(19) United States
(12) Patent Application Publication
(10) Pub. No.: US 2017/0248922 A1
(43) Pub. Date: Aug. 31, 2017

(54) Cover or Faceplate for Electronic Smart Watch

(71) Applicant: Samsonite IP Holdings S.ar.l., Luxembourg (LU)

(72) Inventor: Bryan Lee Hynecek, Redwood City, CA (US)

(73) Assignee: Samsonite IP Holdings S.ar.l., Luxembourg (LU)

(21) Appl. No.: 15/509,788

(22) PCT Filed: Sep. 9, 2015
(86) PCT No.: PCT/IB2015/002061

§ 371 Date: Mar. 8, 2017

Related U.S. Application Data
(60) Provisional application No. 62/048,255, filed on Sep. 9, 2014.

(51) Int. Cl. G04B 37/00; H04B 1/3888; A45C 11/12

(52) U.S. Cl. CPC G04B 37/005; A45C 11/12; H04B 1/3888; H04B 1/3827

(57) ABSTRACT

A cover (100) for a wrist-worn electronic device, which cover (100) includes an exterior layer (101) which forms an exterior of the cover (100), and an interior layer (114) which forms an interior of the cover (100). The interior layer (114) abuts against an exterior of the electronic device when the cover (100) is arranged on the wrist-worn electronic device. The interior layer (114) is attached to the exterior layer (101), and includes a raised bezel (112) which extends further from a face of the wrist-worn electronic device than the exterior layer (101) so as to form at least a part of an exterior surface of the cover (100).

The present application claims priority from U.S. Provisional Patent Application Ser. No. 62/048,255 filed on Sep. 9, 2014, the disclosure of which is incorporated herein by reference in its entirety.

### FIELD OF THE INVENTION

A cover or faceplate for an electronic device such as an electronic computerized or “smart” watch, for example the Apple® Watch, Apple Watch Sport, and Apple Watch Edition.

Sophisticated electronic devices designed to be worn on a user's wrist, know as smart watches, are becoming increasingly common. Such a device typically includes a display screen with a touch sensitive surface to allow the user to interact with the device. A smart watch may also include one or more input mechanism, for example, microphones, buttons, and knobs, as well as ports for connecting the device to other devices, for example, to sync the device with a computer, to connect headphones, to connect the device with a source of charging current, and to communicate wirelessly using an infrared transducer.

Smart watches are susceptible to damage from impacts with hard objects and from mechanical shock. Because these devices are worn on a user's wrist, they may bang into objects are the user moves his or her arms. Moreover, smart watches are designed to provide features useful for athletes and outdoor enthusiasts, for example, heart rate monitor's, pedometers, global positioning systems, and the like. As a result, smart watches are subject to danger from impact during exercise and while playing sports.

Smart watches are also designed to be stylish. They are available in a variety of shapes, colors and designs to appeal to a user's taste. To some extent, the stylish design of a device may be at odds with making the device rugged to withstand rugged treatment. A sleek design suitable to wear in a professional office setting may include less impact protection, making the smart watch more vulnerable to damage when used during exercise.

### SUMMARY OF THE INVENTION

Thus, there is a need to provide a protective cover or faceplate for a smart watch that can protect the delicate mechanical and electronic components of the device that can be removed from the device and that can be easily replaced.

There is also a need for a cover or faceplate for a smart watch that can be attached to a smart watch that allows a user to access the functions of the device.

In one embodiment of the invention there is provided a cover for a wrist-worn electronic device, which cover includes an exterior layer which forms an exterior of the cover, and an interior layer which forms an interior of the cover. The interior layer abuts against an exterior of the electronic device when the cover is arranged on the wrist-worn electronic device. The interior layer is attached to the exterior layer, and includes a raised bezel which extends further from a face of the wrist-worn electronic device than the exterior layer so as to form at least a part of an exterior surface of the cover.

In another embodiment, the exterior layer includes a button opening configured so as to expose a button of the wrist-worn electronic device when the cover is arranged on the wrist-worn electronic device. Also, a portion of the interior layer extends through the button opening in the exterior layer so as to fill the button opening and cover the button of the wrist-worn electronic device when the cover is arranged on the wrist-worn electronic device.

In yet another embodiment, the exterior layer comprises a rigid or semi-rigid material.

In a further embodiment, the exterior layer includes at least one rigid or semi-rigid material selected from the group consisting of plastic materials, rigid rubber materials, engineered thermoplastic materials, polycarbonate materials, and para-aramid materials.

In yet a further embodiment, the interior layer comprises an elastomeric material.

In another embodiment, at least one of the exterior layer and the interior layer includes a cutout configured to at least partially surround a wrist band of the wrist-worn electronic device when the cover is arranged on the wrist-worn electronic device.

In yet another embodiment, the exterior layer includes a face opening configured to expose a face of the wrist-worn electronic device when the cover is arranged on the wrist-worn electronic device, and the raised bezel of the interior portion extends through the face opening of the exterior layer.

In a further embodiment, the cover includes a protective film attached to an interior-facing portion of the cover so as to cover the face opening of the exterior layer.

In yet a further embodiment, the protective film is directly attached to at least one of the interior layer and the exterior layer.

In another embodiment, the protective film allows at least some light to pass through the protective film so that the face of the wrist-worn electronic device is visible when the cover is arranged on the wrist-worn electronic device.

In yet another embodiment, the protective film enables touch inputs to pass through the protective film to the face of the wrist-worn electronic device when the cover is arranged on the wrist-worn electronic device.

In a further embodiment, the protective film enables capacitive-type touch inputs to pass through the protective film to the face of the wrist-worn electronic device when the cover is arranged on the wrist-worn electronic device.

In yet a further embodiment, the protective film comprises at least one material selected form the group consisting of poly(methyl methacrylate), polyethylene terephthalate, other plastics, glass, and polymers.

In another embodiment, the protective film is chemically bonded, adhesively attached, heated, press fitted, ultrasonically welded, or molded to the interior-facing portion of the cover so as to be permanently attached thereto.

In yet another embodiment, the protective film is over-molded, insert-molded, or comolded to the interior-facing portion of the cover.

In a further embodiment, the protective film is irremovably attached to the interior-facing portion of the cover.

In yet a further embodiment, the exterior layer includes a side-dial opening configured to expose a side dial of the wrist-worn electronic device when the cover is arranged on the wrist-worn electronic device.

In another embodiment, the interior layer is comolded, glued, chemically bonded, or heated to the exterior layer so as to be permanently attached thereto.

In yet another embodiment, at least one of the interior layer and the exterior layer includes a bottom edge which is configured to clasp onto a portion of the wrist-worn electronic device so as to secure the cover to the wrist-worn electronic device.

### BRIEF DESCRIPTION OF THE DRAWINGS

Embodiments are illustrated in the figures of the accompanying drawings, which are meant to be exemplary and not limiting, and in which like references are intended to refer to like or corresponding things.

FIGS. 1A-B show an exemplary embodiment.

FIG. 2 shows an exemplary embodiment.

FIGS. 3A-3F show an exemplary embodiment.

FIGS. 4A-4F show an exemplary embodiment.

### DETAILED DESCRIPTION OF THE EMBODIMENTS

According to an embodiment, disclosed is a cover or faceplate for an electronic computerized watch such as a smart watch, for example the Apple® Watch, Apple® Watch Sport, and Apple® Watch Edition. Other examples of smart watches include the Motorola Moto 360, the Samsung Gear 2 Neo, the Samsung Gear Live, the Samsung Gear Fit, the LG G Watch, the Martian Notifier, the Martian Passport, the Cookoo 2 Connected Watch, the MetaWatch M1, the MetaWatch Frame, the MetaWatch Strata, the Pebble Steel, the Pebble Watch, and the Sony SmartWatch 2, to name a few.

Disclosed are embodiments of a protective cover or faceplate 100 or other protective covering for an electronic watch. Embodiments described herein are not limiting but are offered to give a clear understanding.

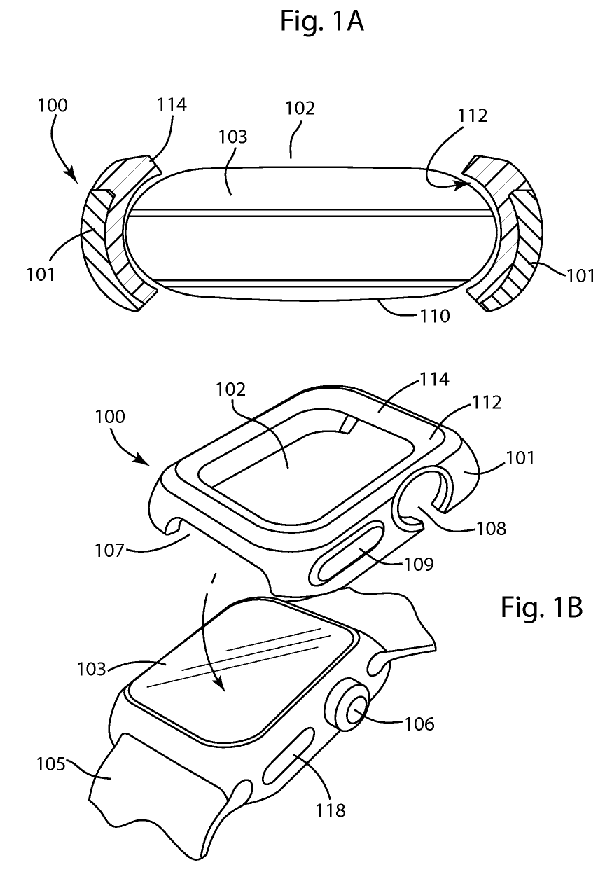

FIGS. 1A-1B shows an embodiment. The cover or faceplate 100 comprises a plastic substrate 101 that can form the exterior portion of the cover or faceplate, and is configured to attach and protectively cover the electronic watch 110. The substrate 101 as shown is fabricated from plastic but can be, for example and without limitation, metal, a rigid or semi-rigid plastic material, a rigid rubber material, engineered thermoplastics, a polycarbonate material, a para-aramid material, and/or some combination thereof and may be any color or texture.

As seen in FIGS. 1A and 1B the exterior layer substrate 101 comprises openings or cutouts configured to provide openings for access to the input components of the watch through an exterior of the cover or faceplate and an opening for viewing and access to the watch display face 103, which comprises an interactive touch screen. Other openings or cutouts 107, 108 also provide access for the cover or faceplate to clear the watch band 105 and for a side dial 106.

Openings 109 also can also be included for ports for access to the input/output components 118, for example, speakers, buttons, jacks, connector ports, microphone ports or holes, sending/receiving ports, and so on.

In an embodiment, as shown in FIGS. 1A and 1B, the cover or faceplate 100 comprises the exterior substrate 101 and at least one interior layer 114. The protective cover or faceplate 100 can include an outer layer formed from the substrate 101 of the protective cover or faceplate 100, comprising two (or more) separate layers, a first external hard shell layer 101 and a second interior elastomeric layer 114. The first external hard shell layer 101 and a second interior elastomeric layer 114 can be combined to independently attach to the watch 110. The second interior elastomeric layer 114 further includes molded elastomeric port openings that form accessible though holes together within the hard shell 101. The external hard shell layer substrate 101 and the interior elastomeric layer 114 may be attached in any of several ways, such as comolding, glue, chemical bonding, heating, heat treated chemicals, or any other means known in the art which permanently attach the external hard substrate 101 to the interior elastomeric layer 114.

The interior elastomeric portion 114 provides scratch and shock protection for the watch 110 from accidental impacts, for example during sports or other activities when wearing the watch 110. The interior elastomeric portion 114 can also ensure the device 114 and the protective cover or faceplate 100 fit together with no gaps where the cover 100 is a single piece assembly.

The interior elastic portion 114 forms a lip over the top of the substrate 101 where it forms the opening 102 above the watch face display 103 that surrounds the opening 103. A raised bezel 112 is formed that protects the display 103 of the watch 110.

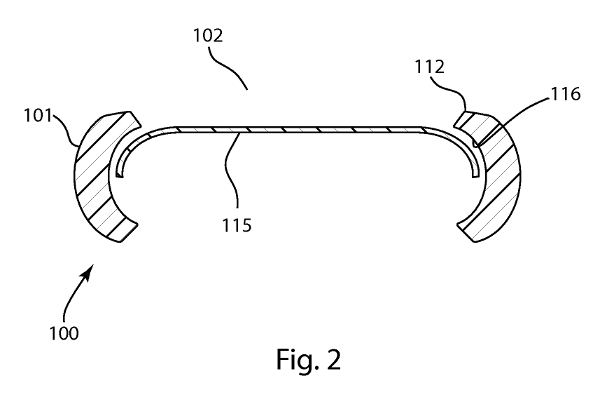

FIG. 2 is a view of an embodiment of the protective cover or faceplate 100. The protective cover or faceplate 100 is fitted to clasp onto the watch. The protective cover or faceplate can be provided with a protective film 115.

The protective film 115 may be transparent, opaque or polarized. It is intended to protect the underlying surface of the device while still allowing the user to view and access the underlying content and to control the device. Plastic film 115 may be comprised of a clear plastic film such as poly(methyl methacrylate) (“PMMA”), polyethylene terephthalate (“PET”), or other plastics, glass, and/or various polymers and sufficiently thin to allow inputs. If it is intended to be used with a capacitance type interface it should be capable of transferring a charge from the user to the device.

Film 115 has an outer surface and an inner surface, wherein the inner surface may contain an adhesive such as silicone, vinyl, micro-suction or any other suitable adhesive. Adhesive may be applied to the entire inner surface of film or may be placed only at select locations on the inner surface. By applying adhesive only in areas not directly in contact with the visible screen area, no trapped air bubbles can form under the film 115 which may obscure the viewing screen. Adhesive may be applied during assembled or manufacturing or may be applied by the end user. Adhesive may be liquid or dry. Protective film 115 may be attached to faceplate or cover 100 using chemical bonding, adhesives, heat, press fitting, ultrasonic welding, over-molding, insert-molding, co-molding, other molding techniques where materials are molded together, or any known molding or bonding method.

In another embodiment the film 115 is not adhered to the screen and/or the faceplate 100 but is removable. The film can be, for example, inserted against an underside 116 of the cover or faceplate 100 such that it is held in place by the substrate 101 and/or cover 100 alone, or held in place by being sandwiched by and pressed between the cover 100 and the watch when the watch is arranged in the cover 100.

The materials used for cover or faceplate 100 can be selected from the following list (or their combinations): plastic, elastic material, rubber, any artificial material, rigid, soft, flexible, wood, glass, mirror, smooth, rough, coarse material or surface, metal, alloy, nylon, cotton, wool, fabric, natural material, convex, concave, flat surface, quartz, transparent, translucent, opaque material, uniform, or non-uniform surface.

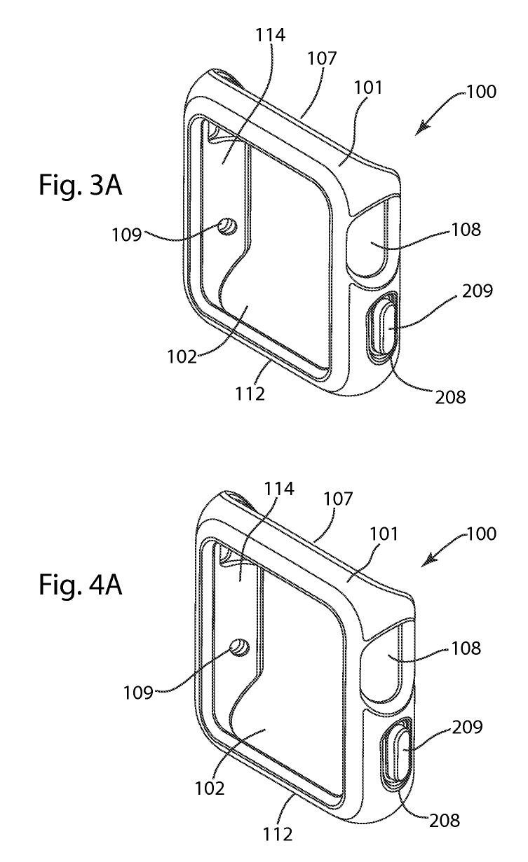

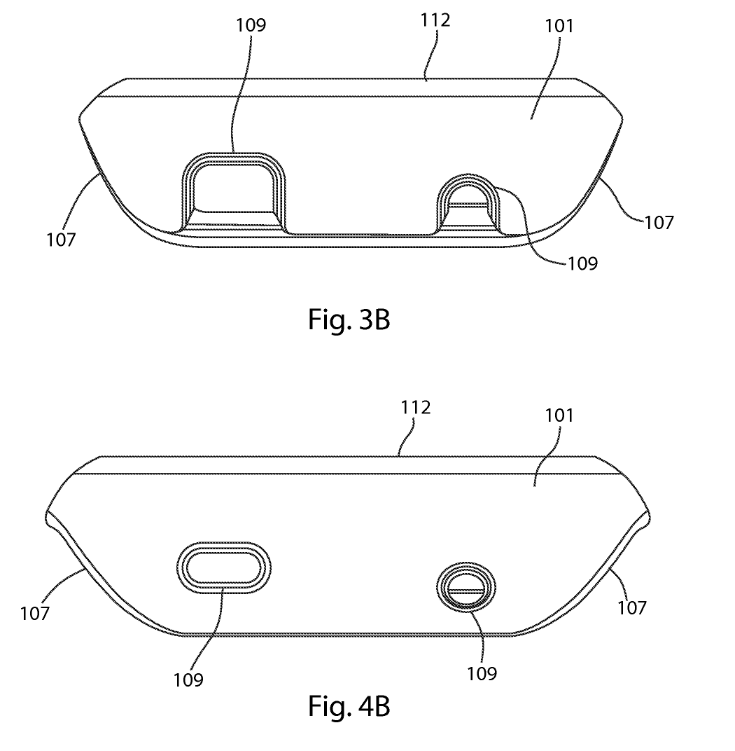

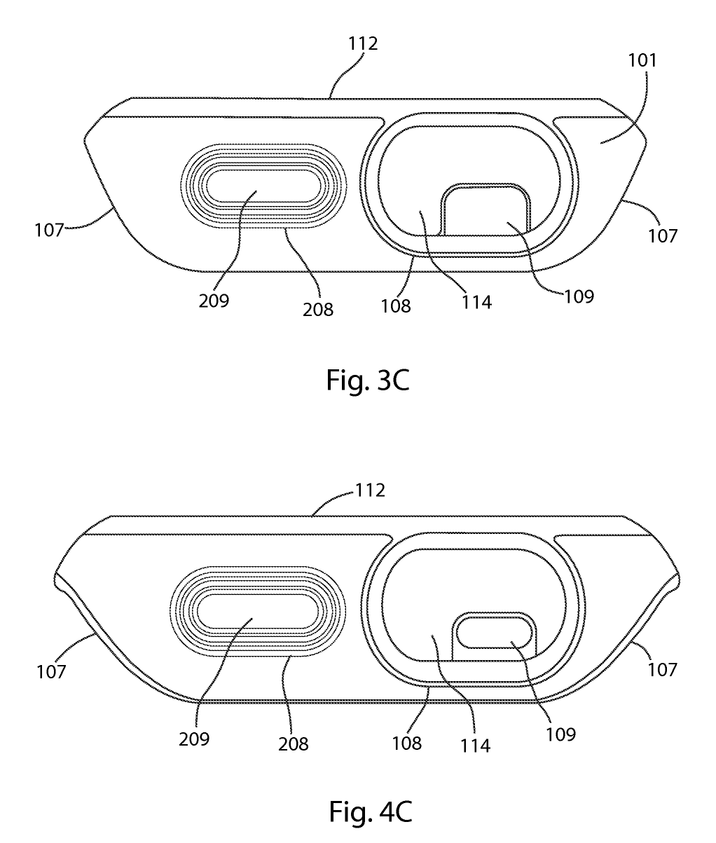

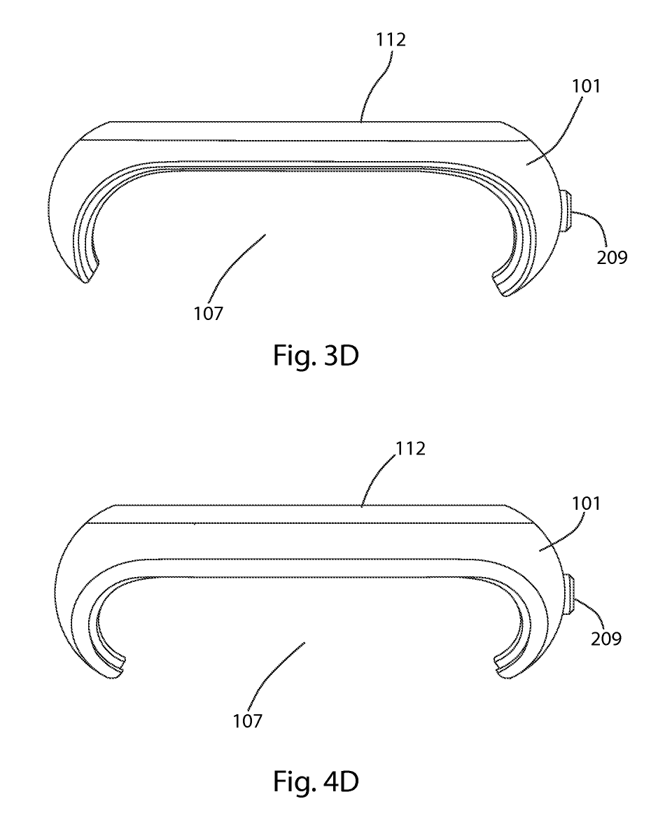

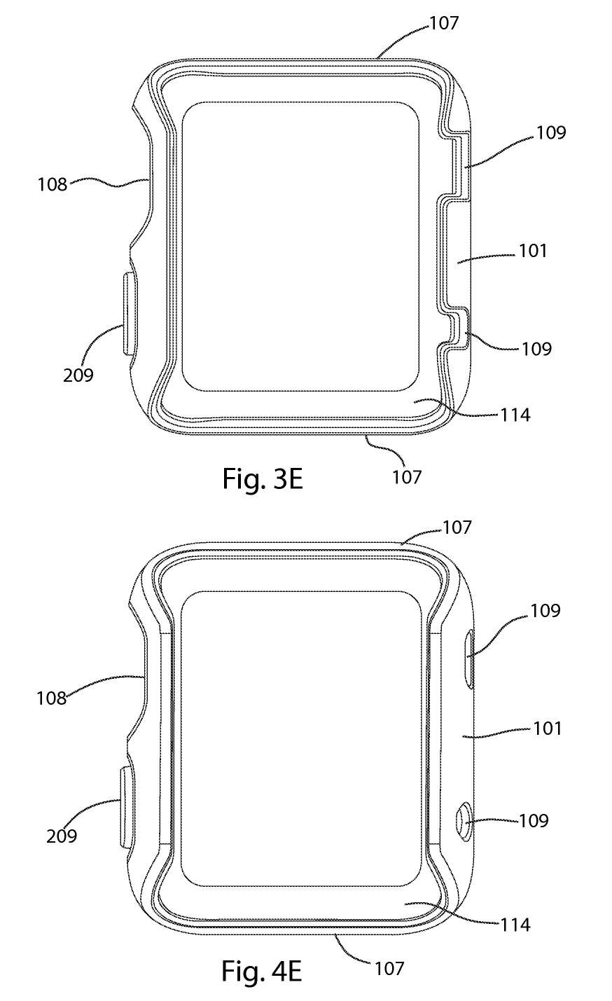

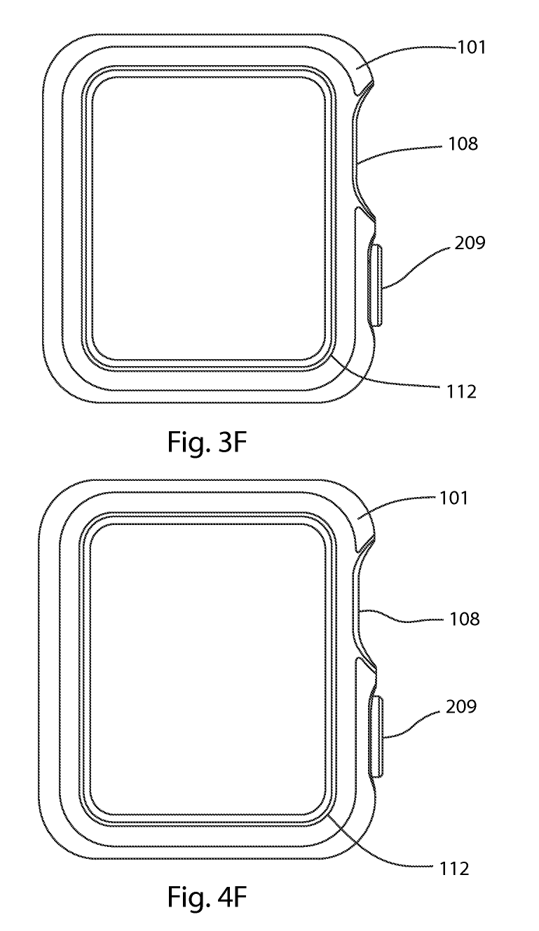

FIGS. 3A-3F and FIGS. 4A-4F show other exemplary embodiments of the cover 100. As shown in these figures, wherein the exterior layer 101 includes a button opening 208 corresponding to a button 118 of the wrist-worn electronic device 110 when the cover 100 is arranged on the wrist-worn electronic device 110. A portion 209 of the interior elastomeric layer 114 extends through the button opening 208 in the exterior layer 101 so as to fill the button opening 208 and cover the button 118 of the wrist-worn electronic device 110 when the cover 100 is arranged on the wrist-worn electronic device 110.

It is appreciated that the optimum dimensional relationships for the parts to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed.

Furthermore, other areas of art may benefit from this method and adjustments to the design are anticipated.

1. A cover for a wrist-worn electronic device, said cover comprising:
an exterior layer which forms an exterior of the cover; and
an interior layer which forms an interior of the cover, and which abuts against an exterior of the electronic device when the cover is arranged on the wrist-worn electronic device;
wherein the interior layer is attached to the exterior layer, and includes a raised bezel which extends further from a face of the wrist-worn electronic device than the exterior layer so as to form at least a part of an exterior surface of the cover.

2. The cover according to claim 1;
wherein the exterior layer includes a button opening configured so as to expose a button of the wrist-worn electronic device when the cover is arranged on the wrist-worn electronic device; and
wherein a portion of the interior layer extends through the button opening in the exterior layer so as to fill the button opening and cover the button of the wrist-worn electronic device when the cover is arranged on the wrist-worn electronic device.

3. The cover according to claim 1;
wherein the exterior layer comprises a rigid or semi-rigid material.

4. The cover according to claim 3;
wherein the exterior layer comprises at least one rigid or semi-rigid material selected from the group consisting of plastic materials, rigid rubber materials, engineered thermoplastic materials, polycarbonate materials, and para-aramid materials.

5. The cover according to claim 1;
wherein the interior layer comprises an elastomeric material.

6. The cover according to claim 1;
wherein at least one of the exterior layer and the interior layer includes a cutout configured to at least partially surround a wrist band of the wrist-worn electronic device when the cover is arranged on the wrist-worn electronic device.

7. The cover according to claim 1;
wherein the exterior layer includes a face opening configured to expose a face of the wrist-worn electronic device when the cover is arranged on the wrist-worn electronic device; and
wherein the raised bezel of the interior portion extends through the face opening of the exterior layer.

8. The cover according to claim 7, further comprising:
a protective film attached to an interior-facing portion of the cover so as to cover the face opening of the exterior layer.

9. The cover according to claim 8;
wherein the protective film is directly attached to at least one of the interior layer and the exterior layer.

10. The cover according to claim 8;
wherein the protective film allows at least some light to pass through the protective film so that the face of the wrist-worn electronic device is visible when the cover is arranged on the wrist-worn electronic device.

11. The cover according to claim 8;
wherein the protective film enables touch inputs to pass through the protective film to the face of the wrist-worn electronic device when the cover is arranged on the wrist-worn electronic device.

12. The cover according to claim 11;
wherein the protective film enables capacitive-type touch inputs to pass through the protective film to the face of the wrist-worn electronic device when the cover is arranged on the wrist-worn electronic device.

13. The cover according to claim 8;
wherein the protective film comprises at least one material selected form the group consisting of poly(methyl methacrylate), polyethylene terephthalate, other plastics, glass, and polymers.

14. The cover according to claim 8;
wherein the protective film is chemically bonded, adhesively attached, heated, press fitted, ultrasonically welded, or molded to the interior-facing portion of the cover so as to be permanently attached thereto.

15. The cover according to claim 14;
wherein the protective film is over-molded, insert-molded, or comolded to the interior-facing portion of the cover.

16. The cover according to claim 8;
wherein the protective film is irremovably attached to the interior-facing portion of the cover.

17. The cover according to claim 1;
wherein the exterior layer includes a side-dial opening configured to expose a side dial of the wrist-worn electronic device when the cover is arranged on the wrist-worn electronic device.

18. The cover according to claim 1;
wherein the interior layer is comolded, glued, chemically bonded, or heated to the exterior layer so as to be permanently attached thereto.

19. The cover according to claim 1;
wherein at least one of the interior layer and the exterior layer includes a bottom edge which is configured to clasp onto a portion of the wrist-worn electronic device so as to secure the cover to the wrist-worn electronic device.
